(19) United States
(12) Patent Application Publication
(10) Pub. No.: US 2010/0114661 A1
(43) Pub. Date: May 6, 2010

(54) Implementing a Promotional Campaign Across a Plurality of Rewards Programs

(75) Inventors: Kimberly A. Alderfer, Hoboken, NJ (US); Scott M. Roen, New York City, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Sevices Company, Inc., New York, NY (US)

(21) Appl. No.: 12/265,280

(22) Filed: Nov. 5, 2008

(51) Int. Cl. G06Q 30/00; G06F 17/30

(52) U.S. Cl. 705/10; 705/14.3

(57) ABSTRACT

Disclosed are methods, computer-program products, and systems for running a promotional campaign across a plurality of rewards programs offered by rewards-program owners. Each rewards program is associated with a rewards currency. In such a method, transactions of members of the rewards programs are monitored to identify a subset of members that performed a desired action. Then, the rewards currency of respective rewards programs is distributed to respective rewards-program owners for the subset of members that performed the desired action.

### BACKGROUND OF THE INVENTION

1. Field of the Invention

The present invention generally relates to loyalty rewards programs.

2. Background Art

Loyalty programs are designed to encourage and increase a particular member behavior. For example, a loyalty program may be points based, in which a member acquires rewards points for performing a desired action (such as, for example, shopping at a particular store, staying at a particular hotel, making purchases with a particular type of credit card, etc.). The member may then receive a reward by redeeming the rewards points. As an alternative example, a loyalty program may provide a cash-back incentive, in which a member receives cash back for performing the desired action. Other types of loyalty programs may also exist.

Various entities may sponsor a loyalty program. The sponsor of a loyalty program provides one or more rewards to members who perform a desired action. For example, a loyalty program may be sponsored by a credit-card issuer (such as, CitiBank of New York, N.Y.; Bank of America Corporation of Charlotte, N.C.; HSBC USA Inc. of New York, N.Y.; or American Express Co. of New York, N.Y.). In this example, the credit-card issuer provides rewards to members who perform a desired action. As another example, a loyalty program may be sponsored by an affiliated partner of a credit-card issuer (such as AMR Corporation of Fort Worth, Tex. or Delta Air Lines, Inc. of Atlanta, Ga.). In this latter example, the affiliated partner provides rewards to the members who perform a desired action, even though the desired action may be associated with use of the credit-card issuer's credit card.

The sponsor and members of a loyalty program both benefit. The sponsor can, for example, increase revenue by selling rewards points or increase revenue based on the members' increased spending with their credit cards. The members can receive rewards—such as, for example, merchandise, gift certificates, charitable donations, cash, or points/miles in a affiliated partner's loyalty program. The members may receive the rewards by redeeming rewards points, by automatic receipt of cash back, or by some other means.

While loyalty programs benefit both sponsors and members, merchants currently may not be able to run promotional programs across multiple loyalty programs. For example, a single merchant (such as, for example, Home Depot, Inc. of Atlanta, Ga.) cannot run a double-points promotional program across multiple rewards programs (such as, for example, CITI® Diamond Preferred® Rewards Credit Card from CitiBank, WorldPoints Rewards from Bank of America, Membership Rewards® from American Express, and AAdvantage® from American Airlines). As a result, merchants are not able to run promotional programs that appeal to a desired target or breadth of customers.

Merchants have dealt with this problem largely by focusing their promotional programs on the biggest loyalty programs (e.g., Membership Rewards®, AAdvantage®, etc.). The sponsors of these loyalty programs have, in turn, developed sales teams to sell rewards to the merchants. Unfortunately, this approach is inefficient and costly for merchants because the merchants focus their promotional programs on only a small subset of potential customers. In addition, this approach results in members receiving unwanted promotional mailings.

Given the foregoing, what is needed are systems, methods, and computer-program products for implementing a promotional campaign across a plurality of rewards programs.

### BRIEF SUMMARY OF THE INVENTION

Embodiments of the present invention meet the above-identified needs by providing methods, computer-program products, and systems for implementing a promotional campaign across a plurality of rewards programs. By delivering such a solution, a universal rewards provider in accordance with an embodiment of the present invention becomes a one-stop shop for merchants across all loyalty programs. In addition to being beneficial to merchants, such a solution provides new channels for loyalty-program owners to sell their rewards.

An embodiment of the present invention provides a method for identifying target customers and running a promotional campaign across a plurality of rewards programs. Each rewards program is associated with a rewards currency. In this method, universal rewards are sold to merchants, wherein the universal rewards are in a currency other than the currency of the plurality of rewards programs. Transactions of members of the plurality of rewards programs are monitored to identify a subset of members that performed a desired action, wherein the subset of members includes a first member of a first rewards program having a first rewards currency and a second member of a second rewards program having a second rewards currency. Then, the rewards currency of respective rewards programs is distributed to respective rewards-program owners for the subset of members that performed the desired action, wherein (i) an amount of the first rewards currency is distributed to a rewards-program owner of the first rewards program according to the desired action performed by the first member and (ii) an amount of the second rewards currency is distributed to a rewards-program owner of the second rewards program according to the desired action performed by the second member.

Another embodiment of the present invention provides a computer-program product including a computer-readable storage medium having control logic stored therein for causing a computer to run a promotional campaign across a plurality of rewards programs. The control logic includes first and second computer-readable program code. The first computer-readable program code is configured to cause the computer to monitor transactions of members of the rewards programs to identify a subset of members that performed a desired action, wherein the subset of members includes a first member of a first rewards program having a first rewards currency and a second member of a second rewards program having a second rewards currency. The second computer-readable program code is configured to cause the computer to distribute the rewards currency of respective rewards programs to respective rewards-program owners for the subset of members that performed the desired action, wherein (i) an amount of the first rewards currency is distributed to a rewards-program owner of the first rewards program according to the desired action performed by the first member and (ii) an amount of the second rewards currency is distributed to a rewards-program owner of the second rewards program according to the desired action performed by the second member.

A further embodiment of the present invention provides a system for running a promotional campaign across a plurality of rewards programs. The system includes a database and a rewards module. The database is configured to store information regarding the rewards program in which respective members are enrolled. The rewards module is coupled to the database and configured to (i) monitor transactions of members of the rewards programs to identify a subset of members that performed a desired action, wherein the subset of members includes a first member of a first rewards program having a first rewards currency and a second member of a second rewards program having a second rewards currency, and (ii) distribute the rewards currency of respective rewards programs to respective rewards-program owners for the subset of members that performed the desired action, wherein an amount of the first rewards currency is distributed to a rewards-program owner of the first rewards program according to the desired action performed by the first member and an amount of the second rewards currency is distributed to a rewards-program owner of the second rewards program according to the desired action performed by the second member.

Further features and advantages of the invention, as well as the structure and operation of various embodiments of the invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a block diagram illustrating an example architecture for implementing a promotional campaign across a plurality of rewards programs offered by a plurality of rewards-program owners.

FIG. 2 depicts an example front end of a universal rewards provider for implementing a promotional campaign across a plurality of rewards programs offered by a plurality of rewards-program owners.

FIG. 3 depicts an example back end of a universal rewards provider for implementing a promotional campaign across a plurality of rewards programs offered by a plurality of rewards-program owners.

FIG. 4 depicts an example universal rewards module for distributing rewards to one of a plurality of rewards-program owners when a member of the one rewards program performs a desired action.

FIG. 5 depicts a block diagram illustrating an example method for implementing a promotional campaign across a plurality of rewards programs offered by a plurality of rewards-program owners.

FIG. 6 depicts an example flow diagram for implementing a promotional campaign across a plurality of rewards programs, wherein the example progression of events depends on the rewards program that each member is associated with.

FIG. 7 depicts a block diagram illustrating an example computer system for implementing embodiments of the present invention.

The features and advantages of embodiments of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Overview

Embodiments of the present invention are directed to implementing promotional campaigns across a plurality of rewards programs, and applications thereof. In this document, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

An embodiment of the present invention provides universal rewards. By using universal rewards, a merchant can offer rewards promotions across a plurality of loyalty programs (e.g., Membership Rewards® offered by American Express, WorldPoints offered by Bank of America, CITI® Diamond Preferred® Rewards offered by CitiBank, etc.).

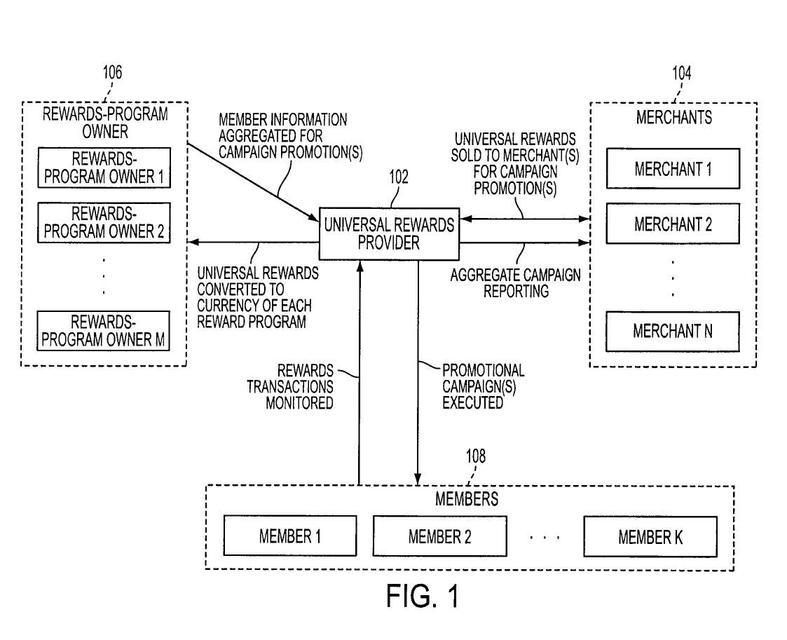

For example, FIG. 1 depicts a block diagram illustrating an overview of architecture for providing universal rewards. In this embodiment, a universal rewards provider 102 (such as, for example, American Express) may sell universal rewards to one or more merchants 104 (such as, for example, Home Depot, Wal-Mart Stores, Inc. of Bentonville, Ark., etc.). Universal rewards provider 102 may execute a promotional campaign across the loyalty programs of rewards-program owners 106 (such as, for example, CitiBank, Bank of America, American Express, etc.) on behalf of the one or more merchants 104. Before executing the promotional campaign, universal rewards provider 102 may aggregate member information from rewards-program owners 106 to determine which members 108 to target in the promotional campaign. The promotional campaign may take the form of a direct mailing, email or other communication channels to members 108 of the various loyalty programs of rewards-program owners 106.

After the promotional campaign, universal rewards provider 102 monitors rewards transactions of members 108 to identify a subset of members 108 that performed a desired action in accordance with the promotional campaign. For example, the desired action may be for members 108 to use their loyalty-program credit cards at merchant 1 during a specified time period. Other types of desired actions will be apparent to persons skilled in the relevant art(s), and these other types of desired actions are within the spirit and scope of the present invention.

Based on the monitored rewards transactions, universal rewards provider 102 manages conversion of the universal rewards to the currency of the loyalty programs of each rewards-program owner 106 of the identified subset of members 108. For example, for the subset of members 108 who are associated with the loyalty program of rewards-program owner 1 and who performed the desired action, universal rewards provider 102 distributes the appropriate rewards to rewards-program owner 1 so that rewards-program owner 1 can place the corresponding rewards into its members' rewards accounts. Then, universal rewards provider 102 may provide aggregate campaign reporting to merchants 104.

Because the universal rewards of embodiments of the present invention enable merchants 104 to run promotional campaigns across a plurality of loyalty programs of rewards-program owners 106, merchants 104 can target a desired breadth of members 108 in a cost-effective and repeatable manner. Unlike conventional promotional campaigns, merchants 104 do not have to focus on only the biggest loyalty programs. As a result, embodiments of the present invention allow merchants 104 to achieve greater scale and targeting of members 108 to drive new business, retain existing business, and win back customers.

The universal rewards of embodiments of the present invention benefit not only merchants 104 but also members 108 and universal rewards provider 102. Members 104 receive rewards promotions in the currency they value and receive less mail that is irrelevant to them. Universal rewards provider 102 may receive increased revenue based on fees associated with the universal rewards system. For example, universal rewards provider 102 may charge a participation fee and may also charge an executive services fee (e.g., a fee for the aggregate campaign reporting to merchants 104).

### II. Example System

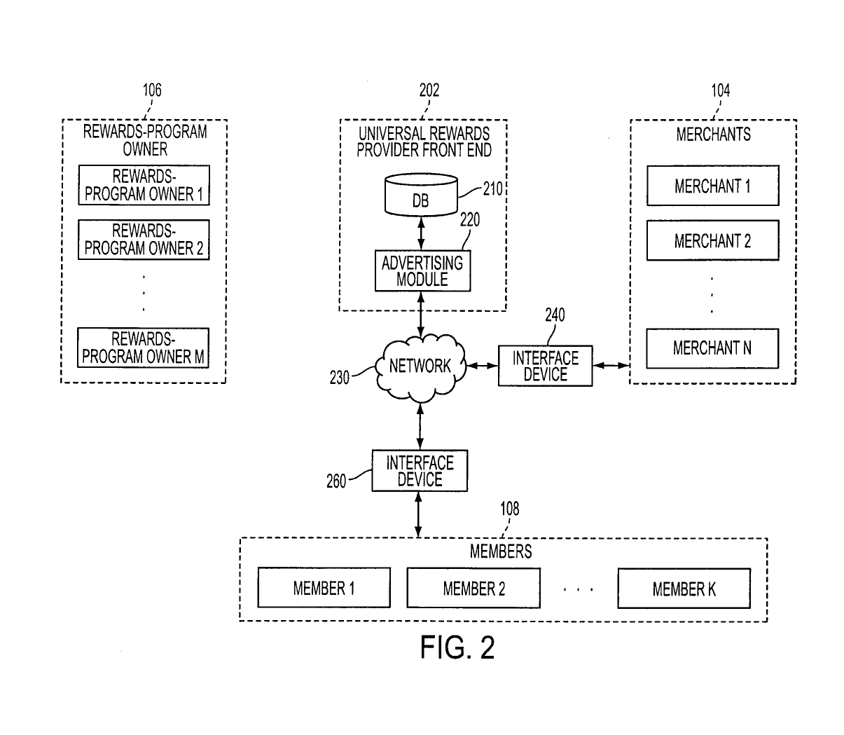

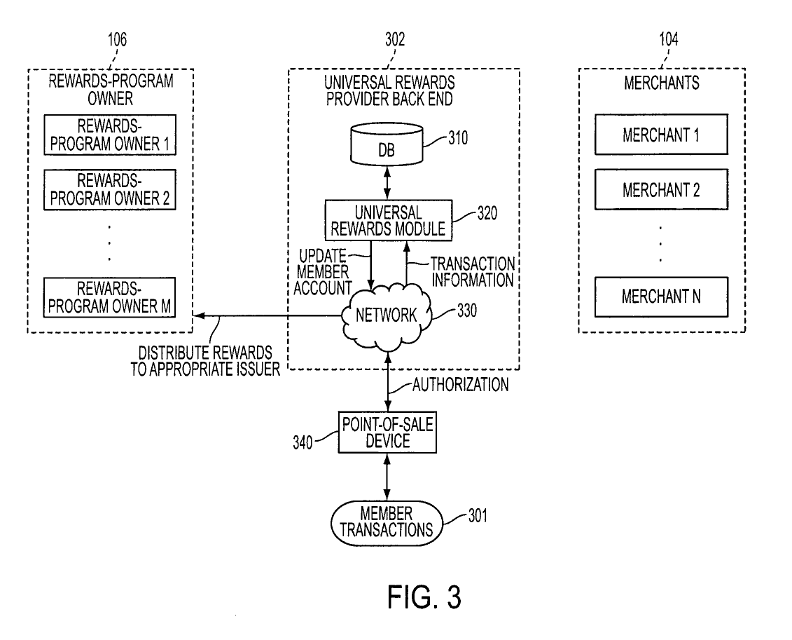

In an embodiment, universal rewards provider 102 administers a universal rewards program in a two-part implementation. In a front-end, universal rewards provider 102 sells universal rewards to merchants 104 and executes the promotional campaign. In a back-end, universal rewards provider 102 monitors the transactions of members 108 and distributes rewards to the appropriate rewards-program owner 106 based on the transactions of members 108. FIGS. 2 and 3 respectively illustrate an example universal rewards provider front end 202 and an example universal rewards provider back end 302.

A. Example Universal Rewards Provider Front End

Referring to FIG. 2, universal rewards provider front end 202 includes a database 210 and an advertising module 220. Advertising module 220 is coupled to a network 230 (such as the Internet). Merchants 104 and members 108 may also be coupled to network 230 via interface devices 240 and 260, respectively. Interface devices 240 and 260 may comprise a computer, a personal digital assistant (PDA), a mobile telephone, a hand-held device, or some other device for coupling to network 230. Although FIG. 2 illustrates only one interface device 240 for merchants 104 and only one interface device 260 for members 108, it is to be understood that this is for illustrative purposes only, and not limitation. It is to be appreciated, for example, that each merchant 104 may have its own interface device for coupling to network 230 and each member 108 may have his or her own interface device for coupling to network 230.

In an embodiment, one or more of merchants 104 buy universal rewards from universal rewards provider 102. Universal rewards provider 102 runs a promotional campaign on behalf of the one or more of merchants 104 that purchased the universal rewards. In an embodiment (not shown), the one or more merchants 104 may buy the universal rewards from universal rewards provider 102 using conventional means (such as, for example, a telephone or a face-to-face meeting). In another embodiment, as illustrated in FIG. 2, one or more merchants 104 may electronically buy the universal rewards from universal rewards provider 102 using interface device 240. For example, one or more merchants 104 may access a website by using a web browser, fill out appropriate information on the website, and submit a request to universal rewards provider front end 202 via network 230. The one or more merchants 104 may pay for the universal rewards in installments or a lump sum or may pay for the universal rewards before or after the promotional campaign is executed or in some other payment scheme as would be apparent to persons skilled in the relevant art(s).

Because the universal rewards are not associated with the currency of any one of the rewards programs of rewards-program owners 106, universal rewards provider 102 can run the promotional campaign across all the rewards programs of rewards-program owners 106. In particular, universal rewards provider 102 determines which members 108 to target in the promotional campaign, irrespective of the rewards program in which members 108 are enrolled. For example, universal rewards provider 102 may compile information on members 108 and store it in database 210. Based on this information, advertising module 220 may run one or more algorithms to identify which members 108 to target in the promotional campaign. Methods for running such targeted promotional campaigns are well known in the relevant art(s) and are not discussed further for the sake of brevity. Advertising module 220 may be implemented in hardware, software, firmware, or a combination thereof.

After determining which members 108 to target, universal rewards provider 102 executes the promotional campaign. For example, advertising module 220 may distribute a plurality of email messages over network 230. Respective members 108 can access respective email messages using interface device 260. Additionally or alternatively, universal rewards provider 102 may execute a direct mailing campaign or some other type of targeted promotional campaign as would be apparent to persons skilled in the relevant art(s). In any event, the advertisement sent to a member 108 may be customized based on the loyalty program of that member 108. For example, as explained in more detail below, if a member is enrolled in the loyalty rewards program of rewards-program owner 1, that member may receive an advertisement that is customized to the loyalty rewards program of rewards-program owner 1; whereas if a member is enrolled in the loyalty rewards program of rewards-program owner 2, that member may receive an advertisement that is customized to the loyalty program of rewards-program owner 2.

B. Example Universal Rewards Provider Back End

Referring to FIG. 3, universal rewards provider back end 302 includes a database 310 and a universal rewards module 320, and utilizes a network 330. In an embodiment, network 330 is a proprietary network maintained by universal rewards provider 102. In another embodiment, network 330 is a community network or public network. Network 330 is coupled to a point-of-sale device 340.

After executing the promotional campaign, universal rewards provider 102 monitors member transactions 301. The member transactions 301 are processed in a typical manner, for example, by using point-of-sale device 340. The transaction information is provided to universal rewards module 320 via network 330. Universal rewards module 320 may be implemented in hardware, software, firmware, or a combination thereof. Universal rewards module 320 may also access information stored in database 310.

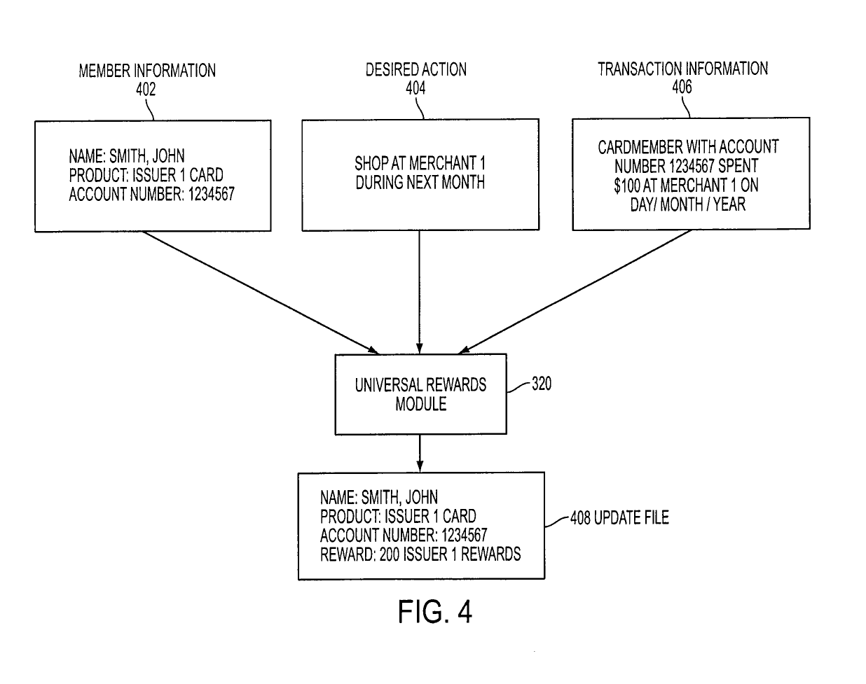

For example, FIG. 4 depicts a block diagram illustrating example information received by universal rewards module 320. In this example, the rewards-program owner is a credit card issuer. This is for illustrative purposes only, and not limitation. Embodiments of the present invention may be implemented for rewards-program owners other than credit card issuers, as would be apparent to persons skilled in the relevant art(s) from the description provided herein.

Referring to FIG. 4, universal rewards module 320 receives member information 402, a desired action 404, and transaction information 406. Member information 402 may be retrieved from database 310 and may include, for example, a member's name, the loyalty program to which the member belongs, and the member's account number. Desired action 404 may also be retrieved from database 310 and specifies the desired action for members 108 to execute in accordance with the promotional campaign (e.g., shop at merchant 1 during the next month). Transaction information 406 may be received from point-of-sale device 340 via network 330 and may specify, for example, a transaction amount, a date of the transaction, and the account number of the member associated with the transaction. Transaction information 406 may other types of information regarding transactions of members 108, as would be apparent to persons skilled in the relevant art(s).

Universal rewards module 320 updates the accounts of members based on the transaction information from point-of-sale device 340 and (optionally) based on information in database 310. Referring again to FIG. 4, universal rewards module 320 may generate an update file 408 based on member information 402, desired action 404, and transaction information 406. Update file 408 may include, for example, the member's name (e.g., Smith, John), product type (e.g., Issuer 1 card), account number (e.g., 1234567), and the amount of rewards currency that the member accumulated from a given transaction (e.g., 200 Issuer 1 Rewards Points).

Referring again to FIG. 3, universal rewards module 320 then distributes the appropriate amount of rewards currency to the appropriate rewards-program owner. From the example depicted in FIG. 4, universal rewards module 320 distributes 200 units of rewards (e.g., 200 rewards points) to rewards-program owner 1 on behalf of the member that is named John Smith and has account number 1234567. In this way, rewards-program owner 1 can keep track of the amount of rewards (e.g., the number of rewards points) that John Smith has accumulated by using his loyalty-program credit card.

In addition to distributing rewards currency to rewards-program owners 106, universal rewards provider 102 may assess each rewards-program owner 106 a fee for participating in such a universal rewards program and may assess other types of fees.

### III. Example Operation

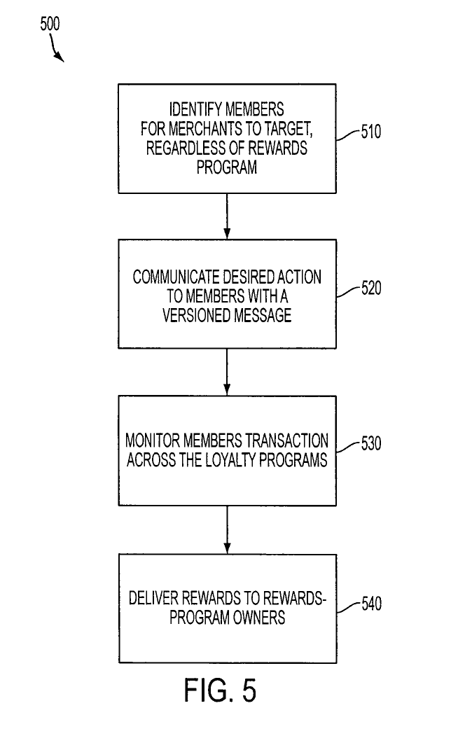

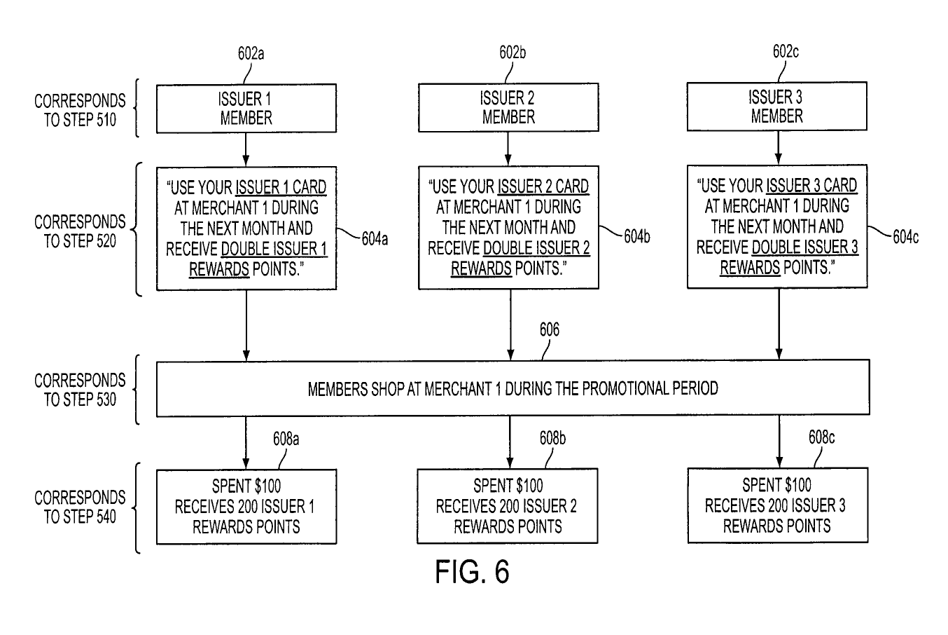

FIG. 5 depicts a block diagram illustrating an example method 500 for running a promotional campaign across a plurality of merchants. Method 500 includes steps 510, 520, 530, and 540. An example implementation of method 500 is described below with reference to the block diagram of FIG. 6. In the example of FIG. 6, the rewards-program owners are depicted as credit card issuers. This is for illustrative purposes only, and not limitation. It is to be appreciated that rewards-program owners other than credit card issuers are contemplated within the spirit and scope of the present invention.

Referring to FIG. 5, method 500 begins at a step 510 in which members are identified for merchants to target in a promotional campaign, regardless of the loyalty program to which each member belongs. For example, FIG. 6 illustrates that step 510 may identify the following members to target in a promotional campaign: (i) a member 602a associated with the loyalty program of issuer 1; (ii) a member 602b associated with the loyalty program of issuer 2; and (iii) a member 602c associated with the loyalty program of issuer 3. In an embodiment, universal rewards provider 102 may identify the members to target using universal rewards provider front end 202 as described above.

In step 520, a desired action is communicated to the identified members using a versioned message. As set forth above, the desired action may be communicated via email, direct mailing, or some other means as would be apparent to a person skilled in the relevant art(s). In this example, members are targeted with a double-points promotional campaign. FIG. 6 illustrates that members 602a,b,c respectively receive messages 604a,b,c encouraging each member 602 to use his or her loyalty-program credit card at merchant 1 during the next month and to receive double rewards points in the currency of his or her loyalty program.

In step 530, members' transactions are monitored across the loyalty programs to identify a subset of the members who satisfied the desired action. As set forth above with respect to FIG. 3, the members' transactions may be monitored by using a standard authorization scheme that is currently implemented for credit-card transactions. As illustrated in box 606 of FIG. 6, each member 602 shopped at merchant 1 during the promotional period.

In step 540, rewards are delivered to the appropriate rewards-program owners for the subset of the members who performed the desired action. For example, box 608a illustrates that member 602a spent $100 at merchant 1 during the promotional period, and therefore 200 loyalty rewards in rewards-program owner 1's loyalty program are distributed to rewards-program owner 1 on behalf of member 602a. In a similar manner, boxes 608b,c illustrate that 200 loyalty rewards in rewards-program owner 2's and rewards-program owner 3's loyalty programs are respectively distributed to rewards-program owner 2 on behalf of member 602b and to rewards-program owner 3 on behalf of member 602c.

Because the universal rewards of embodiments of the present invention can be converted to the currency of several different loyalty programs and distributed to the appropriate rewards-program owner, the universal rewards of embodiments of the present invention enable merchants to run promotional campaigns across the different loyalty programs.

### IV. Example Computer Implementation

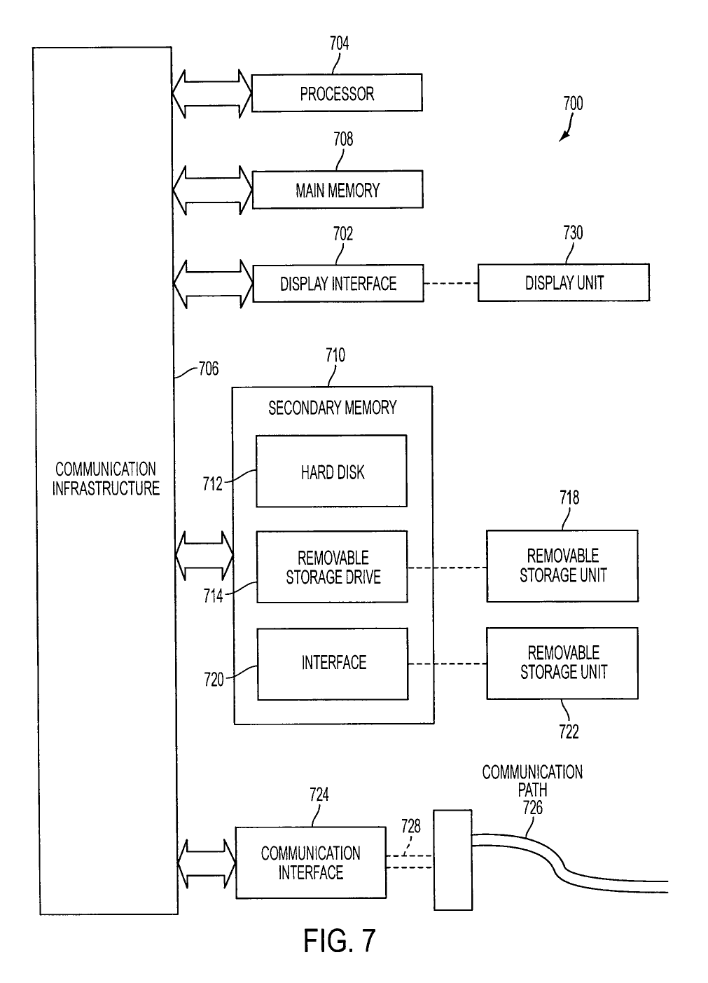

FIG. 7 depicts a block diagram 700 illustrating an example computer system for running a promotional campaign across a plurality of rewards programs owned by rewards-program owners in accordance with an embodiment of the present invention. For example, universal rewards-provider front end 202 and/or back end 302 may be implemented in or by computer system 700.

Computer system 700 includes one or more processors, such as processor 704. Processor 704 may be a general purpose processor (such as, a CPU) or a special purpose processor (such as, a GPU). Processor 704 is connected to a communication infrastructure 706 (such as a communications bus, cross-over bar, or network (e.g., network 230 and/or network 330)). Various software embodiments are described in terms of this exemplary computer system. After reading this description, it will become apparent to a person skilled in the relevant art(s) how to implement the invention using other computer systems and/or architectures.

Computer system 700 includes a display interface 702 that forwards graphics, text, and other data from communication infrastructure 706 (or from a frame buffer not shown) for display on display unit 730.

Computer system 700 also includes a main memory 708, preferably random access memory (RAM), and may also include a secondary memory 710. Secondary memory 710 may include, for example, a hard disk drive 712 and/or a removable storage drive 714, representing a floppy disk drive, a magnetic tape drive, an optical disk drive, etc. Removable storage drive 714 reads from and/or writes to a removable storage unit 718 in a well known manner. Removable storage unit 718 represents a floppy disk, magnetic tape, optical disk, etc. which is read by and written to by removable storage drive 714. As will be appreciated, the removable storage unit 718 includes a computer-readable storage medium having stored therein computer software and/or data.

Secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical or other signals capable of being received by communications interface 724. Signals 728 are provided to communications interface 724 via a communications path (e.g., channel) 726. Channel 726 carries signals 728 and may be implemented using wire or cable, fiber optics, a telephone line, a cellular link, an radio frequency (RF) link and other communications channels.

In this document, the terms “computer program medium” and “computer-readable medium” are used to generally refer to media such as removable storage drive 714 and a hard disk installed in hard disk drive 712. These computer program products provide software to computer system 700. An embodiment of the invention is directed to such computer program products, such as computer program products for running a promotional campaign across a plurality of rewards programs as described herein.

### V. Conclusion

Described above are embodiments for running a promotional campaign across a plurality of loyalty programs, and applications thereof. While various embodiments of the present invention have been described above, it should be understood that they have been presented by way of example only, and not limitation. It will be apparent to persons skilled in the relevant art that various changes in form and detail can be made therein without departing from the spirit and scope of the invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Thus, the breadth and scope of the present invention should not be limited by any of the above-described exemplary embodiments, but should be defined only in accordance with the following claims and their equivalents.

What is claimed is:

1. A method for running a promotional campaign across a plurality of rewards programs, the method comprising:
selling universal rewards to a merchant, wherein the universal rewards are in a currency other than currencies of the plurality of rewards programs;
monitoring transactions of members of the plurality of rewards programs to identify a subset of members that performed a desired action, wherein the subset of members includes a first member of a first rewards program having a first rewards currency and a second member of a second rewards program having a second rewards currency; and
distributing the rewards currency of respective rewards programs to respective rewards-program owners for the subset of members that performed the desired action, wherein (i) an amount of the first rewards currency is distributed to a rewards-program owner of the first rewards program according to the desired action performed by the first member and (ii) an amount of the second rewards currency is distributed to a rewards-program owner of the second rewards program according to the desired action performed by the second member.

2. The method of claim 1, further comprising identifying members of the rewards programs for the merchant to target.

3. The method of claim 2, further comprising advertising to the members of the rewards programs.

4. The method of claim 3, wherein the advertising step comprises:
communicating one of a plurality of messages to respective members identified in the identifying step, wherein the message communicated to a respective member is based on the rewards program in which the respective member is enrolled.

5. The method of claim 1, further comprising:
reporting results of the promotional campaign to the merchant.

6. The method of claim 1, further comprising:
receiving information from respective rewards-program owners regarding the rewards programs in which respective members are enrolled.

7. A computer-program product comprising a computer-readable storage medium having control logic stored therein for causing a computer to run a promotional campaign across a plurality of rewards programs, the control logic comprising:
first computer-readable program code for causing the computer to monitor transactions of members of the plurality of rewards programs to identify a subset of members that performed a desired action, wherein the subset of members includes a first member of a first rewards program having a first rewards currency and a second member of a second rewards program having a second rewards currency; and
second computer-readable program code for causing the computer to distribute the rewards currency of respective rewards programs to respective rewards-program owners for the subset of members that performed the desired action, wherein (i) an amount of the first rewards currency is distributed to a rewards-program owner of the first rewards program according to the desired action performed by the first member and (ii) an amount of the second rewards currency is distributed to a rewards-program owner of the second rewards program according to the desired action performed by the second member.

8. The computer program product of claim 7, further comprising:
third computer-readable program code for causing the computer to identify members of the rewards programs for a merchant to target.

9. The computer program product of claim 8, further comprising:
fourth computer-readable program code for causing the computer to generate a plurality of messages.

10. The computer program product of claim 9, further comprising:
fifth computer-readable program code for causing the computer to communicate one of the plurality of messages to a respective member based on the rewards program in which the respective member is enrolled.

11. The computer program product of claim 7, further comprising:
third computer-readable program code for causing the computer to prepare results of the promotional campaign.

12. The computer program product of claim 7, further comprising:
third computer-readable program code for causing the computer to receive information from respective rewards-program owners regarding the rewards programs in which respective members are enrolled.

13. The computer program product of claim 7, further comprising:
third computer-readable program code for causing the computer to receive a request from a merchant to run the promotional campaign.

14. A system for running a promotional campaign across a plurality of rewards programs, the system comprising:
a database for storing information regarding the rewards program in which respective members are enrolled; and
a rewards module coupled to the database and configured to
(i) monitor transactions of members of the plurality of rewards programs to identify a subset of members that performed a desired action, wherein the subset of members includes a first member of a first rewards program having a first rewards currency and a second member of a second rewards program having a second rewards currency, and
(ii) distribute the rewards currency of respective rewards programs to respective rewards-program owners for the subset of members that performed the desired action, wherein an amount of the first rewards currency is distributed to a rewards-program owner of the first rewards program according to the desired action performed by the first member and an amount of the second rewards currency is distributed to a rewards-program owner of the second rewards program according to the desired action performed by the second member.

15. The system of claim 14, further comprising:
an advertising module configured to identify members of the rewards programs for a merchant to target in the promotional campaign.

16. The system of claim 15, wherein the advertising module is further configured to generate a plurality of message.

17. The system of claim 16, wherein one of the plurality of messages is communicated to a respective member of the rewards programs based on the rewards program in which the respective member is enrolled.

18. The system of claim 14, further comprising:
a module configured to report results of the promotional campaign to the merchant.

19. The system of claim 14, further comprising:
a module configured to receive information from respective rewards-program owners regarding the rewards programs in which respective members are enrolled.

20. The system of claim 14, further comprising:
a module configured to receive a request from a merchant to run the promotional campaign.
